(19) United States
(12) Patent Application Publication
(10) Pub. No.: US 2020/0238878 A1
(43) Pub. Date: Jul. 30, 2020

(54) SIDE BOLSTER TILTING SYSTEM OF VEHICULAR SEAT CUSHION

(71) Applicant: GUMCHANG. CO., LTD., Gyeongsangbuk-do (KR)

(72) Inventors: Jae-Yel SONG, Daegu (KR); Hai-Tai CHOI, Gyeongsangbuk-do (KR); Chae-Sung SONG, Daegu (KR); Sae-Gil SHIN, Daegu (KR); Sang-Ho LEE, Daegu (KR); Min-Sung KIM, Gyeongsangbuk-do (KR); Sung-Su PARK, Gyeongsangbuk-do (KR); Sung-Jin BAEK, Daegu (KR); Yong-Hyeon JOO, Daegu (KR)

(21) Appl. No.: 16/257,995

(22) Filed: Jan. 25, 2019

(51) Int. Cl. B60N 2/90; B60N 2/02

(52) U.S. Cl. CPC B60N 2/99; B60N 2002/0236; B60N 2/0232

(57) ABSTRACT

A side bolster tilting system of a vehicular seat cushion is provided where a worm portion formed on a rotation shaft of a motor is meshed with a worm gear provided to a female threaded tubular shaft in a lower space of a side bolster, a screw shaft engaged to a lifting member in an idling mode is threaded to an upper portion of the female threaded tubular shaft so that the screw shaft is moved up and down by forward or reverse rotation of the female threaded tubular shaft, and an upper portion of the lifting member is fixed to a support plate for supporting the side bolster. By operation of the motor, the side bolster is moved up and down to provide a driver with convenience when the driver gets on or off, and a leather portion of the side bolster is prevented from being worn out.

### BACKGROUND

The present invention relates to a side bolster tilting system of a vehicular seat cushion, and more particularly, to a side bolster tilting system with an improved configuration capable of providing a driver with comfortability by moving a side bolster up or down when the driver gets on or off.

In general, vehicular seats include a head rest, a seat back and a seat cushion so that a driver and passengers can comfortably sit in the seats.

In order to provide the driver and the passengers with comfortability, the vehicular seat is provided with several convenient devices, for example, a seat positioning device for moving the whole seat in all directions, a lumbar supporter installed to a seat back, or a side bolster provided to left and right sides of a seat cushion.

The seat cushion is configured to support hips of a driver, and is provided with side bolsters along left and right sides of the seat cushion to support left and right sides of a lower body of the driver, thereby preventing a center of the driver from leaning to one side at a sharp turn of a car.

The side bolsters which are convex portions of the left and right sides of the seat cushion protrude integrally from a main frame, so that an upper cushion is always maintained in a protruding state.

If the side bolsters are continuously maintained in the protruding state from the left and right sides of the seat cushion, the driver experiences inconvenience while riding the car.

Since the height of the bolster cannot be raised, the function of preventing the driver from leaning to one side at the sharp turn of the car is degraded.

In particular, if the side bolsters are continuously maintained in the protruding state from the left and right sides of the seat cushion, the bolster portion repeatedly rubs with the hips or lower body of the driver while riding the car, so that the leather portion of the side bolster is worn out which causes whitening phenomenon, and the leather is pinched. Therefore, the appearance of the seat cushion is not good.

In order to solve the above drawbacks of the vehicular seat cushion, a new side bolster is disclosed in Korean Patent No. 10-1326491, but has some problems in that a power transmission configuration for operating the side bolster is complicated, and a plate-type tilting device installed in the side bolster has a poor durability.

### SUMMARY OF THE INVENTION

Therefore, the present invention has been made in view of the above problems, and one object of the present invention is to provide a side bolster tilting system of a vehicular seat cushion that can maximize an effect of tilting operation, as well as being easily installed in a narrow space of the seat cushion, and having a simple configuration.

Another object of the present invention is to provide a side bolster tilting system of a vehicular seat cushion, in which a side bolster is moved up and down to provide a driver with convenience when a driver gets on or off, and a leather portion of the side bolster is prevented from being worn out

In order to achieve the above objects, there is provided a side bolster tilting system of a vehicular seat cushion, wherein a motor is mounted to a frame by a bracket in a lower space of a side bolster provided to one side of a seat cushion.

A female threaded tubular shaft is provided with a worm gear which is meshed with a worm portion formed on a rotation shaft of the motor, so that a rotating force of the rotation shaft of the motor is transmitted to the female threaded tubular shaft.

A screw shaft which is engaged to a lifting member in an idling mode is fastened to the female threaded tubular shaft, with the lifting member being fixed to a support plate for supporting the side bolster, so that the side bolster is moved up or down by forward or reverse rotation of the female threaded tubular shaft.

The lifting member is supported by a guide to stably move the side bolster.

With the above configuration, since the side bolster tilting system can be installed in the lower narrow space of the side bolster of the seat cushion, which can be applied to a compact car with a small seat cushion.

Also, the effect of the tilting operation can be structurally maximized, and a vehicular seat cushion with the simple configuration can obtain the above side bolster tilting operation. Since the side bolster operates when getting into and out of the car, it is possible to prevent the leather of the side bolster from being worn out.

### BRIEF DESCRIPTION OF THE DRAWINGS

FIG. 1 is a perspective view illustrating a seat equipped with a side bolster tilting system according to one embodiment of the present invention.

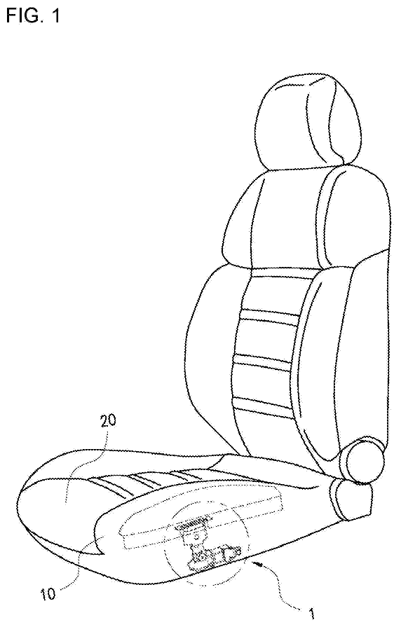

FIG. 2 is an enlarged perspective view illustrating the side bolster tilting system according to the embodiment of the present invention.

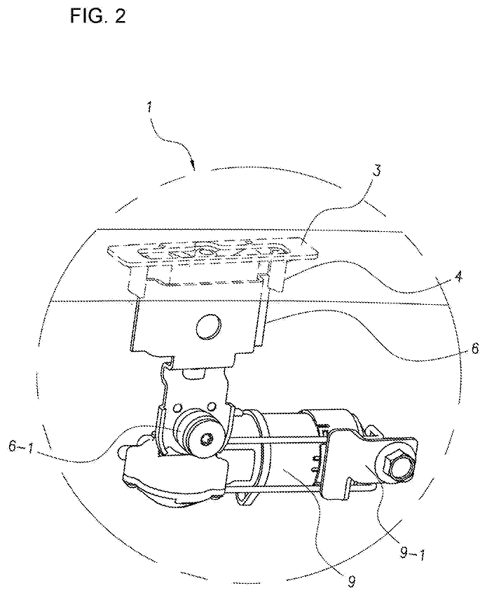

FIG. 3 is a side view illustrating a seat cushion equipped with the side bolster tilting system according to the embodiment of the present invention.

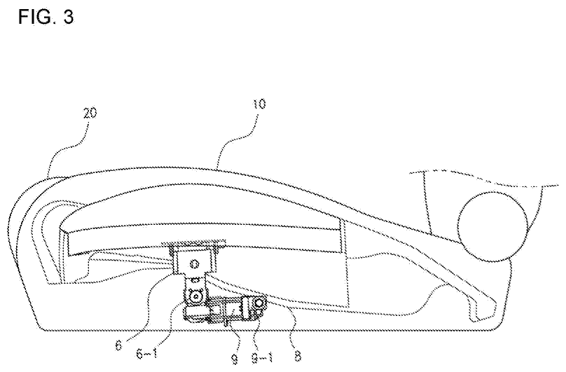

FIG. 4 is a view illustrating a state in which the side bolster is moved up according to the embodiment of the present invention.

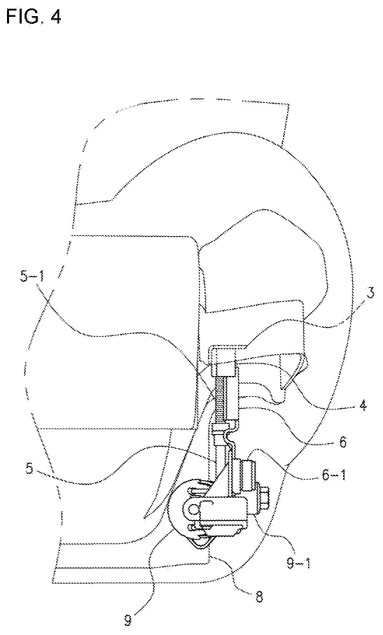

FIG. 5 is a view illustrating a state in which the side bolster is moved down according to the embodiment of the present invention.

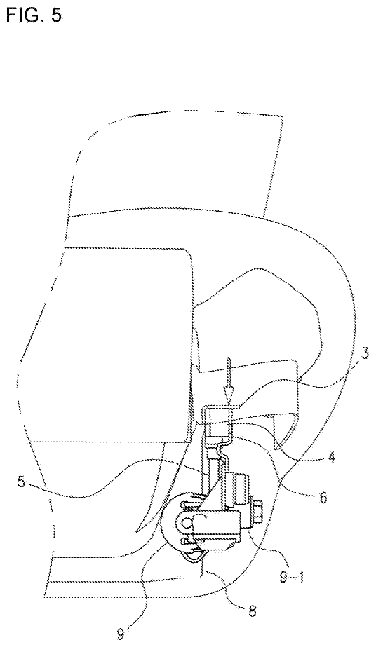

FIG. 6 is a perspective view illustrating a power transmission structure for the side bolster tilting system according to one embodiment of the present invention.

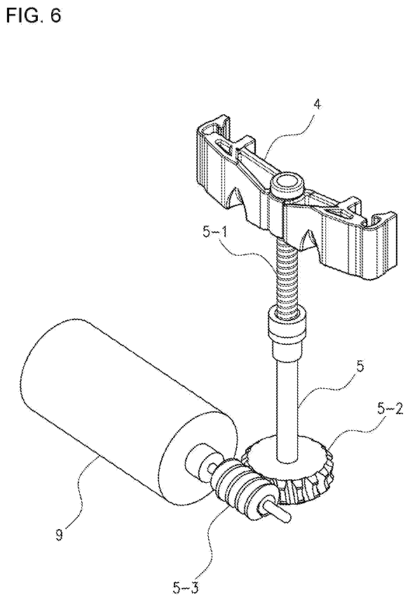

FIG. 7 is a perspective view illustrating a power transmission structure for the side bolster tilting system according to another embodiment of the present invention.

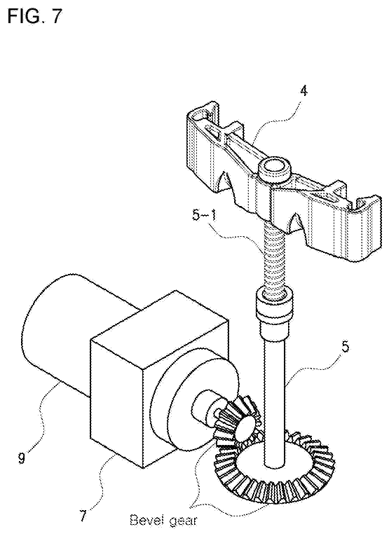

### DETAILED DESCRIPTION OF THE PREFERRED EMBODIMENT

Hereinafter, embodiments of the present invention will be explained in detail with reference to the accompanying drawings.

In a side bolster tilting system of a vehicular seat cushion according one embodiment of the present invention, a motor 9 is mounted to a frame 8 by a bracket 9-1 in a lower space of a side bolster 10 provided to one side of a seat cushion 20.

A rotation shaft of the motor 9 is provided with a worm portion 5-3 to transmit a rotating force to a female threaded tubular shaft 5 which is installed in a direction perpendicular to a rotating direction of the rotation shaft of the motor 9, and the lower portion of the female threaded tubular shaft 5 is provided with a worm gear 5-2, thereby transmitting the rotation of the motor to the female threaded tubular shaft 5.

An upper portion of the female threaded tubular shaft 5 is fastened to a screw shaft 5-1 which is engaged to a lifting member 4 in an idling mode, so that the lifting member 4 is operated by forward or reverse rotation of the female threaded tubular shaft 5.

An upper portion of the lifting member 4 is fixed to a support plate 3 for supporting the side bolster to move the support plate 3 up and down, and a side of the lifting member is guided and supported by a guide 6.

In addition, the rotation shaft of the motor 9 is provided with a speed reducer 7 for reducing a speed of the rotation shaft, and since the speed reducer 7 has a general configuration, the detailed description thereof will be omitted herein. A rotation shaft of the speed reducer and the female threaded tubular shaft 5 employ the bevel gear to change the rotating direction, other means can be employed.

The side bolster tilting system 1 is configured in such a way that the upper portion of the female threaded tubular shaft 5 is meshed with the screw shaft 5-1 which is engaged to the lifting member 4 in the idling mode, the upper portion of the lifting member 4 is fixed to the support plate 3 for supporting the side bolster, and the side of the lifting member is supported by the guide 6 to be moved up and down.

The motor 9 of the side bolster tilting system 1 may be rotated forwardly or reversely according to a signal of a sensor which detects a signal generated when a vehicular door is opened or closed, or may be manually operated by a separate switch (not illustrated).

The operation of the side bolster tilting system 1 of the vehicular seat cushion according to the embodiment of the present invention will now be described in detail.

With the configuration of the side bolster tilting system 1 of the vehicular seat cushion according to the embodiment of the present invention, the motor 9 can be manually operated by the separate switch (not illustrated), or can be operated by the signal of the sensor (not illustrated) which detects the signal generated when the door is opened or closed. Hereinafter, the case where the side bolster tilting system is operated by the signal of the sensor will be described.

Specifically, the rotation shaft is rotated forwardly or reversely by the motor 9 which is operated by the sensor detecting the opening or closing motion of the door. When the door is opened, the motor 9 is operated to rotate the rotation shaft and the worm portion 5-3 formed on the rotation shaft in the forward direction, to transmit the rotation to the worm gear 5-2 formed on the lower portion of the female threaded tubular shaft 5 which is meshed with the worm portion 5-3, thereby forwardly rotating the female threaded tubular shaft 5.

The screw shaft 5-1 fastened to the female threaded tubular shaft 5 enters the inside of the female threaded tubular shaft 5, so that the lifting member 4 engaged to the upper portion of the screw shaft 5-1 in the idling mode is moved down together with the screw shaft 5-1.

If the lifting member 4 is moved down, the support plate 3, to which the lifting member is fixed, for supporting the side bolster is moved down with the side bolster 10. Since the side of the lifting member 4 is guided by the guide 6, the side bolster 10 can be stably moved down. When a driver gets off in the state in which the side bolster is moved down, it is possible to prevent hips or a lower body of the driver from pressing the side bolster or coming into contact with the side bolster, thereby preventing the leather of the side bolster from being worn out and providing the driver with comfortability while riding the car.

When the driver takes a seat and closes the door, the motor 9 is rotated reversely, and thus the worm portion 5-3 formed on the rotation shaft of the motor 9 transmits the rotation to the worm gear 5-2 provided to the lower portion of the female threaded tubular shaft 5, so that the female threaded tubular shaft 5 is reversely rotated.

Thus, the screw shaft 5-1 fastened to the female threaded tubular shaft 5 gets out from the inside of the female threaded tubular shaft 5, so that the lifting member 4 engaged to the upper portion of the screw shaft 5-1 in the idling mode is moved up.

If the lifting member 4 is moved up, the support plate 3, to which the lifting member 4 is fixed, for supporting the side bolster is moved up with the side bolster 10. Since the side of the lifting member 4 is guided by the guide 6, the side bolster 10 can be stably moved up. If the side bolster is moved up, the side bolster adheres to the hips and lower body of the driver, thereby providing the driver with the sense of stability.

Alternatively, when the driver opens or closes the door of the car, the motor 9 operates to forwardly or reversely rotate a bevel gear for changing the rotating direction by the speed reducer 7.

Thus, the female threaded tubular shaft 5 is forwardly or reversely rotated, and the screw shaft 5-1 fastened to the female threaded tubular shaft 5 comes in or out from the female threaded tubular shaft 5, so that the lifting member 4 fixed to the support plate 3 for supporting the side bolster is also moved down or up. Even when the side bolster operates as described above, the screw shaft 5-1 engaged to the female threaded tubular shaft 5 idles relative to the lifting member 4. Since the side of the lifting member is guided and supported by the guide 6, the side bolster 10 can be stably moved up and down.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A side bolster tilting system of a vehicular seat cushion, wherein
a motor (9) is mounted to a frame (8) by a bracket (9-1) in a lower space of a side bolster (10) provided to one side of a seat cushion (20);
a female threaded tubular shaft (5) is provided with a worm gear (5-2) which is meshed with a worm portion (5-3) formed on a rotation shaft of the motor (9), so that a rotating force of the rotation shaft of the motor is transmitted to the female threaded tubular shaft (5);
a screw shaft (5-1) which is engaged to a lifting member (4) in an idling mode is fastened to the female threaded tubular shaft (5), with the lifting member being fixed to a support plate (3) for supporting the side bolster (10), so that the side bolster (10) is moved up or down by forward or reverse rotation of the female threaded tubular shaft (5); and
the lifting member (4) is supported by a guide (2) to stably move the side bolster (10).

2. The side bolster tilting system of the vehicular seat cushion according to claim 1, wherein the side bolster is detachably provided to one side of the seat cushion.

3. The side bolster tilting system of the vehicular seat cushion according to claim 1, wherein a bevel gear is interposed between a speed reducer (7) and the female threaded tubular shaft (5).
